(19) United States
(12) Patent Application Publication
(10) Pub. No.: US 2014/0215801 A1
(43) Pub. Date: Aug. 7, 2014

(54) Method of securing a musical instrument stand to a flat surface

(71) Applicant: Christopher George Schaff, Morton, IL (US)

(72) Inventor: Christopher George Schaff, Morton, IL (US)

(21) Appl. No.: 13/998,446

(22) Filed: Nov. 1, 2013

Related U.S. Application Data
(60) Provisional application No. 61/759,954, filed on Feb. 1, 2013.

(51) Int. Cl. G10G 5/00

(52) U.S. Cl. CPC G10G 5/00
USPC 29/525.01

(57) ABSTRACT

A method of securing a musical instrument stand to a platform surface. This method allows efficient and repeatable positioning of a musical instrument stand onto a platform surface thus saving a musician time and effort during setup and tear down.

### FIELD OF THE INVENTION

The present invention relates to setup of musical instruments that require a stand, and, more particularly, reducing setup time and effort of musicians.

### BACKGROUND OF THE INVENTION

Most musicians, especially drummers who play drum set, require frequent setup and teardown of a group of instruments on stands for performance purposes. Often the musician must setup instruments in a performance or rehearsal venue. Upon completion of the performance, the musician must relocate the instruments to another venue in a different location for the next performance. This repeated setup and teardown requires time and effort for which the musician is not necessarily paid. Therefore to minimize the time, effort and variability of instrument placement during setup and teardown this invention will allow the musician to complete this task faster and more efficiently.

Existing methods of supporting musical instruments include using tripod stands that fold up and the use of metal racks to mount instruments to.

Tripod stands do not allow for precise relative location from one setup to the next. As tripod stands are located independently from each other, the setup locations often need to be fine tuned to achieve proper positioning of the entire set of instruments. When locating musical instrument stands on a platform, tripod stands require extra space to accommodate the unfolded legs. Metal racks usually do not require tripods but require multiple metal tubes to secure musical instruments. This requires extra weight and cost. Neither tripod stands nor racks are usually attached to a platform, rather they are typically held in place by gravity.

It is therefore an object of the invention to reduce setup and tear down time of musical instruments that require stands on a platform surface.

It is another object of the invention to improve location repeatability of a set of musical instruments requiring stands placed on a platform surface.

It is another object of the invention to reduce the cost of hardware required to mount a musical instrument stand onto a platform surface.

It is another object of the invention to reduce the weight of hardware required to mount a musical instrument onto a platform surface.

### SUMMARY OF THE INVENTION

In accordance with the present invention, there is provided a method of securing a musical instrument stand to a platform surface. This method allows efficient and repeatable positioning of a musical instrument stand onto a platform surface thus saving a musician time and effort during setup and tear down.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an instrument stand mounting system attached to a platform surface with a musical instrument stand attached to the base mount;

FIG. 2 is a front view of an instrument stand mounting system sub structure and stabilizing rod shown with fasteners and anti rotation feature;

FIG. 3 is an isometric view of an instrument stand mounting system with four mounting fasteners;

FIG. 4 is an isometric view of an instrument stand mounting system shown above a platform surface;

FIG. 5 is an isometric view of an instrument stand mounting system secured to a platform surface;

FIG. 6 is a front view of an instrument mounting system shown with an instrument stand above and aligned to the instrument mounting system;

FIG. 7 is an isometric view of an instrument mounting system shown with an instrument stand above and aligned to the instrument mounting system;

FIG. 8 is a front view of an instrument mounting system shown with an instrument stand attached to the instrument mounting system on a platform surface;

FIG. 9 is an isometric view of an instrument mounting system shown with an instrument stand attached to the instrument mounting system on a platform surface;

FIG. 10 is an isometric view of a multiple instrument mounting systems supporting a set of musical instruments;

FIG. 11 is an isometric view of a sub structure and stabilizing rod with a gap between to form a groove pocket; and

FIG. 12 is an exploded view of a sub structure and stabilizing rod to illustrate the bottom of the groove pocket.

For purposes of clarity and brevity, like elements and components will bear the same designations and numbering throughout the FIGURES.

### DESCRIPTION OF THE PREFERRED EMBODIMENT.

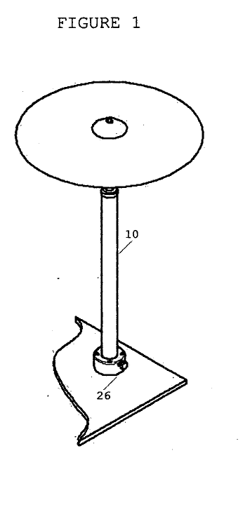

FIG. 1 is a perspective view of an instrument stand mounting system 26 attached to a platform surface 20. A musical instrument 22 stand is attached to the instrument stand mounting system 26. The sub structure 12 of the instrument stand mounting system 26 is fastened to the platform surface 20 in the desired location by using mounting fasteners 18.

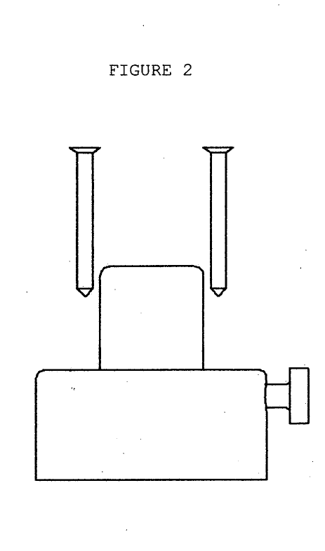

FIG. 2 is a front view of sub structure 12 and stabilizing rod 14 shown with Mounting fasteners 18 and Anti rotation feature 16.

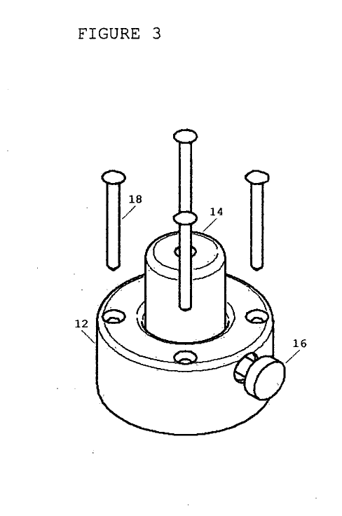

FIG. 3 is an isometric view of an instrument stand mounting system 26 base with Mounting fasteners 18. Integral to the sub structure 12 is the stabilizing rod 14 which protrudes into the upright tube 10. The upright tube 10 is placed over the stabilization rod into the groove pocket 24 in the sub structure 12 where it is radially located using an anti rotation feature 16.

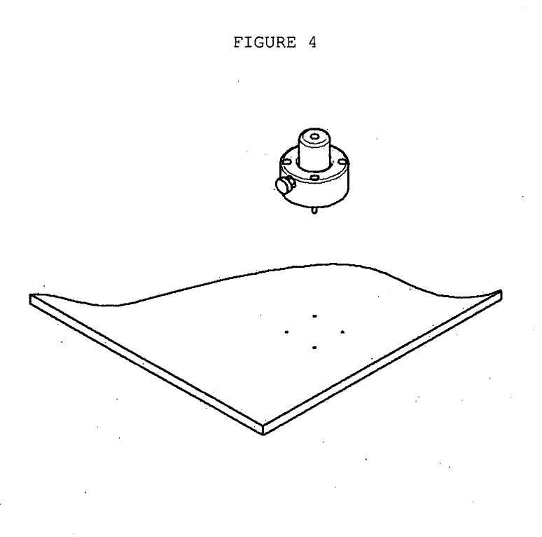

FIG. 4 is an isometric view of an instrument stand mounting system 26 base shown above a platform panel. The location where the instrument stand mounting system 26 is fastened to the platform surface 20 can be changed by removing the Mounting fasteners 18 from the sub structure 12 and repositioning and refastening the instrument stand mounting system 26 to another position on the platform surface 20 using mounting fasteners 18.

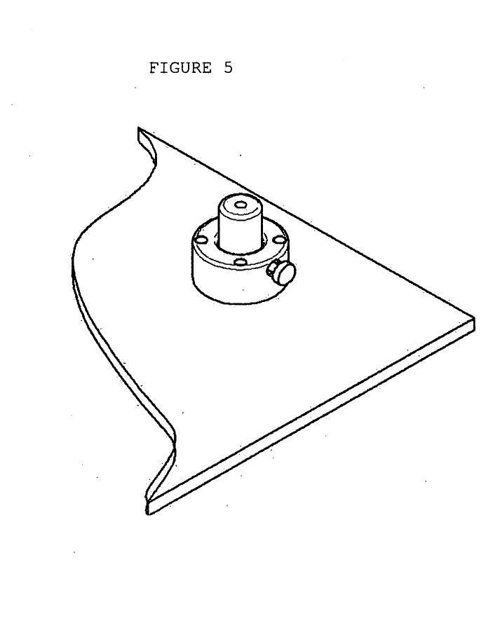

FIG. 5 is an isometric view of an instrument stand mounting system 26 base secured to a platform panel using mounting fasteners 18.

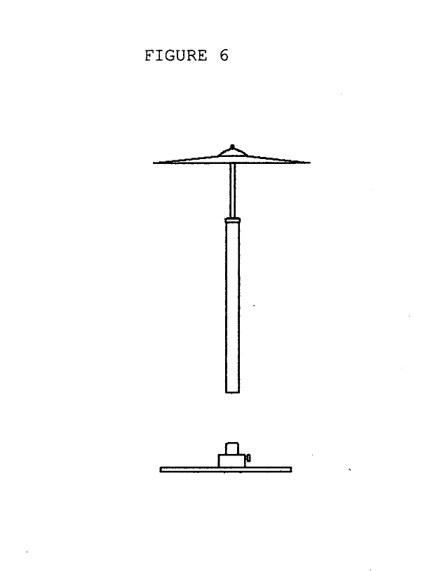

FIG. 6 is a front view of an instrument stand shown above and aligned to the instrument mounting system. The Mounting fasteners 18 allow for securing the instrument stand mounting system 26 to a platform surface 20 on a desired location. The Mounting fasteners 18 attach the instrument stand mounting system 26 through holes in the sub structure 12. This provides easy setup of an upright tube 10 with attached musical instrument 22 at the desired location on the platform surface 20 as determined by the position of the instrument stand mounting system 26.

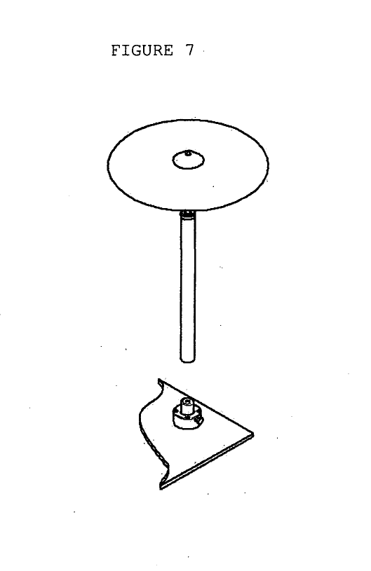

FIG. 7 is an isometric view of an instrument mounting system shown with an instrument stand above and aligned to the instrument mounting system base. With the instrument stand mounting system 26 secured in the desired location on the platform surface 20, instrument stand setup is easily achieved by inserting the upright tube 10 into the groove pocket 24 in the instrument stand mounting system 26. After completion of the performance, the musician can easily remove the upright tube 10 from the instrument stand mounting system 26 and leave the instrument stand mounting system 26 attached to the platform surface 20 during transport.

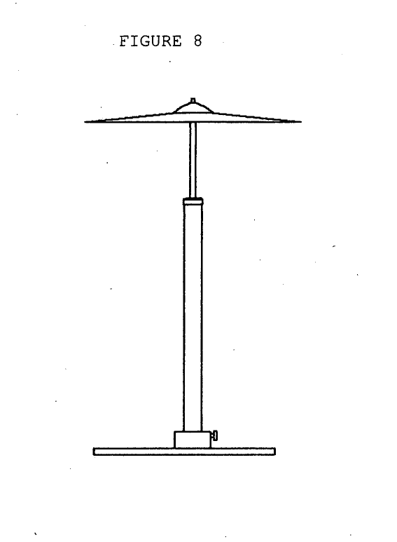

FIG. 8 is a front view of an instrument mounting system shown with an instrument stand attached to the instrument mounting system base on a platform panel. After the upright tube 10 is placed over the stabilizing rod 14 and into the groove pocket 24 in the sub structure 12, the Anti rotation feature 16 can engage the upright tube 10 to prevent torsional motion of the upright tube 10 and musical instrument 22 while the musical instrument 22 is being played.

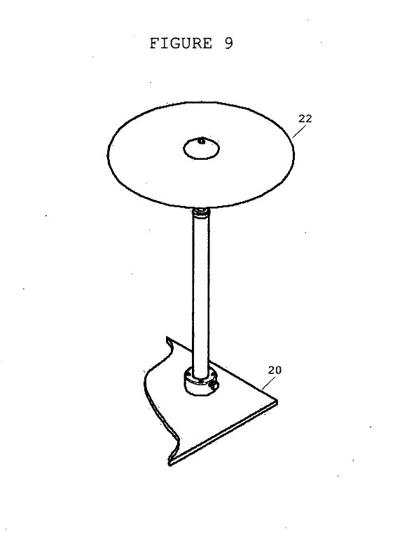

FIG. 9 is an isometric view of an instrument stand mounting system 26 secured to a platform surface 20 shown with an instrument stand attached to the upright tube 10.

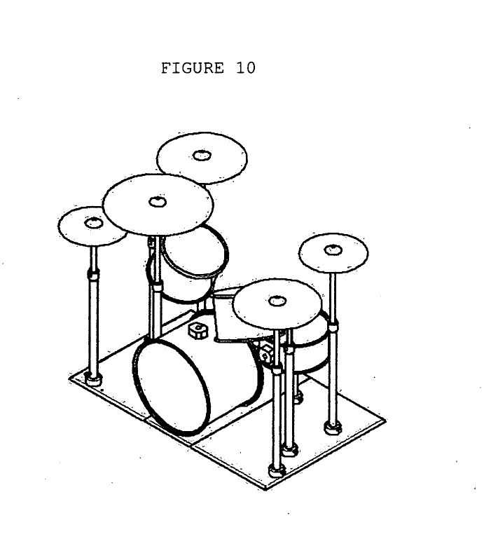

FIG. 10 is an isometric view of more than one instrument stand mounting system 26 supporting a set of musical instruments mounted on more than one upright tube 10. Using more than one instrument stand mounting system 26 on a platform surface 20 for a set of musical instruments is set up greatly reduces positional variation of a set of musical instrument 22 from one setup to the next.

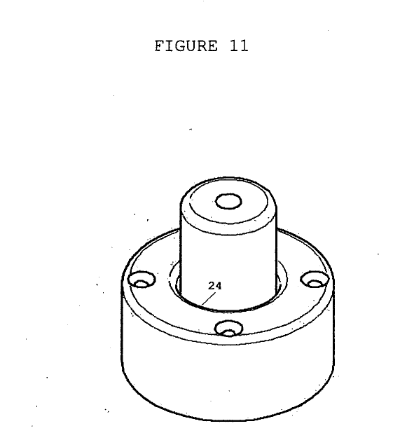

FIG. 11 is an isometric view of a gap between the sub structure 12 and stabilizing rod 14 forming a groove pocket 24. The groove pocket 24 is a gap between the sub structure 12 and the stabilizing rod 14 to allow the bottom of an upright tube 10 to engage. This groove pocket 24 allows sub structure 12 to provide support the the bottom and outside of the upright tube 10 and prevent axial motion. The stabilizing rod 14 further prevents axial motion of the upright tube 10 as it penetrates inside the upright tube 10 and stabilizes the tube from inside while a musical instrument 22 is attached and being played.

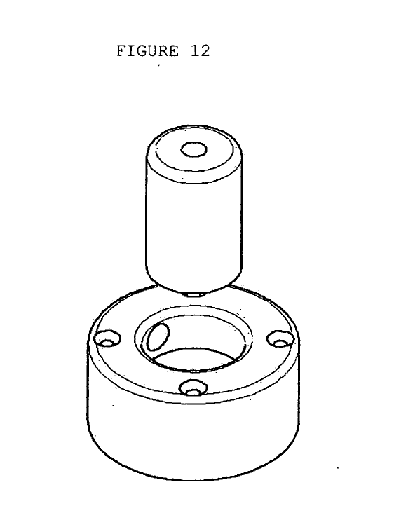

FIG. 12 is an exploded view of a sub structure 12 and stabilizing rod 14 to illustrate the bottom of the groove pocket 24. The bottom of the groove pocket 24 provides a solid surface to vertically position the upright tube 10 during musical instrument 22 setup.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of securing a musical instrument stand to a flat surface for reducing setup time for musicians. comprising:
means for providing vertical positioning support of a musical instrument;
means for providing structural foundation to musical instrument stand, temporally connected to said means for providing vertical positioning support of a musical instrument;
means for protruding into the inside of the upright tube to provide stability to upright tube when mounted into the groove pocket in the sub structure, coaxially anchored to said means for providing structural foundation to musical instrument stand, and rigidly stabilized to said means for providing vertical positioning support of a musical instrument;
means for prohibiting radial motion of the upright tube and musical instrument when mounted into the sub structure, perpendicularly connected to said means for providing structural foundation to musical instrument stand, and radially engaged to said means for providing vertical positioning support of a musical instrument;
means for temporarily fastening the sub structure to a platform surface at the desired position, securely fastened to said means for providing structural foundation to musical instrument stand;
means for providing a support surface upon which to secure the sub structure of the instrument stand mounting system, temporarily secured to said means for temporarily fastening the sub structure to a platform surface at the desired position;
means for being mounted on the upright tube in a position suitable for a musician to play, axially secured to said means for providing vertical positioning support of a musical instrument;
means for preventing tilting motion of the upright tube while under load from use and providing a bottom surface to vertically locate the upright tube; and
means for securing a musical instrument stand upright tube to a platform.

2. The method of securing a musical instrument stand to a flat surface in accordance with claim 1, wherein said means for providing vertical positioning support of a musical instrument comprises an upright tube.

3. The method of securing a musical instrument stand to a flat surface in accordance with claim 1, wherein said means for providing structural foundation to musical instrument stand comprises a sub structure.

4. The method of securing a musical instrument stand to a flat surface in accordance with claim 1, wherein said means for protruding into the inside of the upright tube to provide stability to upright tube when mounted into the groove pocket in the sub structure comprises a stabilizing rod.

5. The method of securing a musical instrument stand to a flat surface in accordance with claim 1, wherein said means for prohibiting radial motion of the upright tube and musical instrument when mounted into the sub structure comprises an anti rotation feature.

6. The method of securing a musical instrument stand to a flat surface in accordance with claim 1, wherein said means for temporarily fastening the sub structure to a platform surface at the desired position comprises a mounting fasteners.

7. The method of securing a musical instrument stand to a flat surface in accordance with claim 1, wherein said means for providing a support surface upon which to secure the sub structure of the instrument stand mounting system comprises a platform surface.

8. The method of securing a musical instrument stand to a flat surface in accordance with claim 1, wherein said means for being mounted on the upright tube in a position suitable for a musician to play comprises a musical instrument.

9. The method of securing a musical instrument stand to a flat surface in accordance with claim 1, wherein said means for preventing tilting motion of the upright tube while under load from use and providing a bottom surface to vertically locate the upright tube comprises a groove pocket.

10. The method of securing a musical instrument stand to a flat surface in accordance with claim 1, wherein said means for securing a musical instrument stand upright tube to a platform comprises an instrument stand mounting system.

11. A method of securing a musical instrument stand to a flat surface for reducing setup time for musicians. comprising:
an upright tube, for providing vertical positioning support of a musical instrument;
a sub structure, for providing structural foundation to musical instrument stand, temporally connected to said upright tube;
a stabilizing rod, for protruding into the inside of the upright tube to provide stability to upright tube when mounted into the groove pocket in the sub structure, coaxially anchored to said sub structure, and rigidly stabilized to said upright tube;
an anti rotation feature, for prohibiting radial motion of the upright tube and musical instrument when mounted into the sub structure, perpendicularly connected to said sub structure, and radially engaged to said upright tube;
a mounting fasteners, for temporarily fastening the sub structure to a platform surface at the desired position, securely fastened to said sub structure;
a platform surface, for providing a support surface upon which to secure the sub structure of the instrument stand mounting system, temporarily secured to said Mounting fasteners;
a musical instrument, for being mounted on the upright tube in a position suitable for a musician to play, axially secured to said upright tube;
a groove pocket, for preventing tilting motion of the upright tube while under load from use and providing a bottom surface to vertically locate the upright tube; and
an instrument stand mounting system, for securing a musical instrument stand upright tube to a platform.

12. A method of securing a musical instrument stand to a flat surface for reducing setup time for musicians. comprising:
an upright tube, for providing vertical positioning support of a musical instrument;
a sub structure, for providing structural foundation to musical instrument stand, temporally connected to said upright tube;
a stabilizing rod, for protruding into the inside of the upright tube to provide stability to upright tube when mounted into the groove pocket in the sub structure, coaxially anchored to said sub structure, and rigidly stabilized to said upright tube;
an anti rotation feature, for prohibiting radial motion of the upright tube and musical instrument when mounted into the sub structure, perpendicularly connected to said sub structure, and radially engaged to said upright tube;
a mounting fasteners, for temporarily fastening the sub structure to a platform surface at the desired position, securely fastened to said sub structure;
a platform surface, for providing a support surface upon which to secure the sub structure of the instrument stand mounting system, temporarily secured to said Mounting fasteners;
a musical instrument, for being mounted on the upright tube in a position suitable for a musician to play, axially secured to said upright tube;
a groove pocket, for preventing tilting motion of the upright tube while under load from use and providing a bottom surface to vertically locate the upright tube; and
an instrument stand mounting system, for securing a musical instrument stand upright tube to a platform.
